(19) United States
(12) Patent Application Publication
(10) Pub. No.: US 2023/0016917 A1
(43) Pub. Date: Jan. 19, 2023

(54) INFORMATION PROCESSING APPARATUS AND INFORMATION PROCESSING METHOD

(71) Applicant: TOYOTA JIDOSHA KABUSHIKI KAISHA, Toyota-shi (JP)

(72) Inventors: Yukinori II, Toyota-shi (JP); Kenji YAMAGUCHI, Miyoshi-shi (JP); Junya OGAWA, Okazaki-shi (JP); Yuki NAGANUMA, Nagoya-shi (JP); Junya YAMAMOTO, Seto-shi (JP); Yuta TONE, Nagoya-shi (JP); Naoki ISHIZUKA, Nagoya-shi (JP); Tadayuki TANAKA, Nagoya-shi (JP); Keisuke ITO, Okazaki-shi (JP); Yuka YOKOI, Miyoshi-shi (JP); Takashi HAYASHI, Nagoya-shi (JP); Naoya OKA, Nagakute-shi (JP); Yu HAMADA, Nagoya-shi (JP)

(73) Assignee: TOYOTA JIDOSHA KABUSHIKI KAISHA, Toyota-shi (JP)

(21) Appl. No.: 17/844,976

(22) Filed: Jun. 21, 2022

(30) Foreign Application Priority Data
Jul. 19, 2021 (JP) 2021-118851

(51) Int. Cl. G06Q 30/02; G06Q 10/00; G06Q 10/06

(52) U.S. Cl. CPC G06Q 30/0207; G06Q 10/20; G06Q 10/063112

(57) ABSTRACT

An information processing apparatus disclosed is run by a business entity that provides the service of buying and selling used vehicles or a business entity that provides the service of leasing vehicles. When the business entity buys a first vehicle having a first coating film including an easily removable layer applied thereon from a first user or receives such a first vehicle returned by a first user, if the first coating film was removed at a specific site, a controller of the information processing apparatus executes a processing for giving an incentive to the first user, The value of the incentive to be given to the first user is calculated on the basis of the length of time elapsed since the time at which the first coating film was removed at the specific site.

### CROSS REFERENCE TO THE RELATED APPLICATION

This application claims the benefit of Japanese Patent Application No. 2021-118851, filed on Jul. 19, 2021, which is hereby incorporated by reference herein in its entirety.

### BACKGROUND

### Technical Field

The present disclosure relates to an information processing apparatus and an information processing method.

### Description of the Related Art

There is a known technology to give a reward (money, an item, or points) to a user of a vehicle when the user performs a specific operation relating to the vehicle that can be carried out by a person who is not a car mechanic (see, for example, Patent Literature 1 in the following citation list).

### Citation List

### Patent Literature

Patent Literature 1: Japanese Patent Application Laid-Open No. 2020-064552

### SUMMARY

An object of this disclosure is to provide a technology that helps management of records of operations relating to coating of vehicles.

According to one aspect of the technology disclosed herein, there is provided an information processing apparatus comprising, for example, a controller including at least one processor, the controller being programmed to execute the processing of giving an incentive to a first user who sells or returns a first vehicle from which a first coating film including an easily removable layer was removed at a specific site,

According to another aspect of the technology disclosed herein, there is provided an information processing method comprising, for example, the processing executed by a computer of giving an incentive to a first user who sells or returns a first vehicle from which a first coating film including an easily removable layer was removed at a specific site.

According to still another aspect of the technology disclosed herein, there is provided an information processing apparatus comprising a controller including at least one processor, the controller being programmed to execute the processing of giving an incentive to a first user who sells or returns a first vehicle of which a record of the operation of removing a first coating film including an easily removable layer is stored in a server apparatus that manages history records of operations relating to the first coating films of a plurality of vehicles.

According to other aspects, there are also provided an information processing program configured to cause a computer to implement the above-described information processing method and a non-transitory storage medium in which such an information processing program is stored.

According to this disclosure, there is provided a technology that helps management of history records of operations relating to coating of vehicles.

### BRIEF DESCRIPTION OF THE DRAWINGS

FIG. 1 is a diagram illustrating the general configuration of a used vehicle sales system according to an embodiment.

FIG. 2 is a diagram illustrating a first exemplary structure of a coating film applied to a first vehicle.

FIG. 3 is a diagram illustrating a first exemplary structure of the coating film applied to the first vehicle.

FIG. 4 is a diagram illustrating exemplary hardware configurations of a first server apparatus and a second server apparatus included in the used vehicle sales system according to the embodiment.

FIG. 5 is a block diagram illustrating an exemplary functional configuration of the first server apparatus according to the embodiment.

FIG. 6 illustrates how a coefficient Cf1 is determined in the system according to the embodiment.

FIG. 7 is a block diagram illustrating an exemplary functional configuration of the second server apparatus according to the embodiment.

FIG. 8 illustrates an exemplary structure of a record information table stored in a record management database according to the embodiment.

FIG. 9 is a flow chart of a processing routine executed by the first server apparatus according to the embodiment.

FIG. 10 is a flow chart of a subroutine executed by the first server apparatus according to the embodiment.

FIG. 11 illustrates how a first correction factor Cfa1 is determined in the system according to a first modification of the embodiment.

FIG. 12 illustrates how a second correction factor Cfa2 is determined in the system according to a second modification of the embodiment.

FIG. 13 illustrates how a third correction factor Cfa3 is determined in the system according to a third modification of the embodiment.

FIG. 14 is a diagram illustrating the general configuration of a used. vehicle sales system according to another embodiment.

### DESCRIPTION OF THE EMBODIMENTS

There is a known technique of applying a removable coating to a vehicle body using a coating film including an easily removable layer. Such a coating film will be referred to as “first coating film” hereinafter. The first coating film is a removable coating that is applied on the original coating applied on the vehicle body in the process of manufacturing the vehicle. The original coating is produced, for example, by forming an electrodeposition layer (or primer coat) on the steel plate constituting the vehicle body and laminating an intercoat layer, a base layer, and a clear layer (or topcoat) on the electrodeposition layer. The original coating is not easy to remove, because its removal requires a particular solution, such as a remover. In contrast, the first coating film is made up of, for example, an easily removable layer in the form of a film formed on the original coating and a coating film (including, for example, a base layer and a clear layer) formed on the easily removable layer and can be removed easily by application of force without need for using a particular solution, The first coating film itself may be a film that can be removed (i.e. easily removable coating).

Since the first coating film can be easily removed as described above, it is possible to change the body color at a desired time. For example, when purchasing or leasing a vehicle, one can select the original coating of a color that is popular in the resale market or the like and use the vehicle after applying a first coating film of a color different from the color of the original coating. When selling or returning the vehicle, one can change the body color back to the color of the original coating by removing the first coating film. Thus, when the color the user prefers is different from the colors popular in the resale market or the like, it is possible to meet the user's need while maintaining the resale value of the vehicle.

The above-described first coating film applied to a vehicle provides protection for the film of the original coating, thereby possibly increasing the resale value of the vehicle as compared to vehicles to which the first coating film is not applied. This makes it easier to find the next purchaser or lessee of the vehicle, and the vehicle can be sold or leased at a higher price or fee.

If the first coating film has not been removed at the time when the vehicle is sold to the next purchaser or leased to the next lessee, the cost and effort are required to remove the first coating film. If it is possible to motivate the user to sell or return the vehicle after removing the first coating film, the cost and effort required before selling the vehicle bought from the user to the next purchaser or leasing the vehicle returned by the user to the next lessee can be reduced. However, if the history of operations relating to the first coating film is unknown, it will be difficult to know the history and the present condition of the vehicle. For example, at the time immediately after the removal of the first coating film, the outer appearance of the vehicle would look like brand new, and there can be cases where the condition of the outer appearance does not agree with the other conditions of the vehicle. This can make it difficult for business entities that provide the service of buying and selling used vehicles or business entities that provide the service of leasing vehicles to determine the value of the vehicle correctly. Moreover, the above situation can make users as potential next purchasers or lessees hesitant to buy or lease the vehicle. Therefore, it is desired to motivate the user who sells or returns the vehicle to remove the first coating film in a manner that can maintain a history record of operations relating to the first coating film.

The information processing apparatus disclosed herein has a controller configured to give an incentive to a user who sells or returns a first vehicle from which a first coating film (or a coating film including an easily removable layer) was removed at a specific site. The specific site mentioned here is a site that can be provided with means for keeping a record of an operation relating to the first coating film of the first vehicle. This specific site may be a site, such as a maintenance workshop or a car dealer, provided with a terminal used to upload data of operations relating to the first coating film of the first vehicle to a server apparatus that manages history records of operations relating to the first coating films of a plurality of vehicles including the first vehicle. Thus, the first user can be offered an incentive in reward for selling or returning the first vehicle after removing the first coating film at the specific site. This can motivate the first user to sell or return the first vehicle after removing the first coating film at the specific site. Therefore, the cost and effort required before selling leasing the first vehicle to the next purchaser or lessee of the first vehicle can be reduced. Moreover, it is possible to keep a history record of operations relating to the first coating film of the first vehicle. This helps management of the history record of operations relating to the first coating film of the first vehicle.

In connection with the above, the term “selling the first vehicle” refers to the first user's act of selling the first vehicle to a business entity that provides the service of buying and selling used vehicles or trading the first vehicle in for a new vehicle at a business entity that provides the service of selling new vehicles. The term “returning the first vehicle” refers to the first user's act of returning the first vehicle to a business entity that provides the service of leasing the first vehicle.

The aforementioned history record of operations relating to the first coating film of the first vehicle may include a record of the operation of applying the first coating film on the original coating of the first vehicle and a record of the operation of removing the first coating film from the first vehicle. This makes it possible to manage the records of the operation of applying the first coating film on the original coating of the first vehicle and the operation of removing the first coating film from the first vehicle,

In the case where the server apparatus manages the history records of operations relating to the first coating films of a plurality of vehicles including the first vehicle, the controller of the information processing apparatus may execute the processing of sending a request for first information including the history record of operations relating to the first coating film of the first vehicle to the server apparatus, receiving the first information from the server apparatus, and determining whether an incentive is to be given to the first user on the basis of the first information. Thus, the controller can determine whether the operation of removing the first coating film of the first vehicle was performed at the specific site on the basis of the first information. For example, if a record of the operation of removing the first coating film of the first vehicle performed at the specific site is included in the first information, the controller may determine that the operation of removing the first coating film of the first vehicle was performed at the specific site. In this case, the controller may determine that an incentive is to be given to the first user if a record of the operation of removing the first coating film of the first vehicle performed at the specific site is not included in the first information, the controller may determine that the operation of removing the first coating film of the first vehicle was not performed at the specific site. In this case, the controller may determine that an incentive is not to be given to the first user.

The aforementioned first information may further include information about a first date and time at which the operation of removing the first coating film of the first vehicle was performed at the specific site. In this case, if it is determined that an incentive is to be given to the first user, the controller may calculate the value of the incentive to be given to the first user on the basis of the first date and time. For example, the controller may calculate the value of the incentive to be given to the first user in such a way that the shorter the length of time elapsed since the first date and time is, the larger the value of the incentive is. This is because the appearance of the original coating from which the first coating film has been removed can deteriorate with increasing length of time elapsed since the removal of the first coating film. This way of determining the incentive can motivate the first user to sell or return the first vehicle before the length of time elapsed since the removal of the first coating film at the specific site becomes long. In other words, this way of determining the incentive can motivate the first user to remove the first coating film at the specific site immediately before selling or returning the first vehicle.

The first information may further include information about the skill level of the specific site at which the operation of removing the first coating film from the first vehicle was performed. In this case, the controller may calculate the value of the incentive to be given to the first user in such a way that the higher the skill level of the specific site is, the larger the value of the incentive is. This is because the higher the skill level of the specific site is, the lower the possibility of damaging the original coating or leaving marks of removal in the process of removing the first coating film is. This way of determining the incentive can motivate the first user to sell or return the first vehicle after removing the first coating film at a specific site with a higher skill level.

The first information may further include information about a first site at which the first coating film was applied to the first vehicle. In this case, the controller may calculate the value of the incentive to be given to the first user larger in the case where the specific site is the same as the first site than when the specific site is not the same as the first site. This is because if the specific site is the same as the first site, it is considered that the first coating film could be removed by a method suitable for the properties of the first coating film applied to the first vehicle. This way of determining the incentive can motivate the first user to sell or return the first vehicle after removing the first coating film at the specific site at which the first coating film was applied.

The first information may include second information relating to the outer appearance of the first vehicle before the removal of the first coating film and third information relating to the outer appearance of the first vehicle after the removal of the first coating film. In this case, the controller may calculate the proportion of the area over which the coating film was removed on the basis of the second information and the third information and then calculate the value of the incentive to be given to the first user in such a way that the higher the proportion is, the larger the value of the incentive is. The proportion of the area over which the first coating film was removed refers to the ratio of the area over which the first coating film was removed at the specific site to the area over which the first coating film had been applied to the first vehicle. This way of determining the incentive can motivate the first user to sell or return the first vehicle after removing the first coating film over a larger area at the specific site. This can lead to a reduction in the cost and effort required before selling the first vehicle to the next purchaser or leasing the first vehicle to the next lessee.

In order to keep the history record of operations relating to the first coating film of the first vehicle, the operation of unloading a record of the operation of removing the first coating film may be conducted by the first user. For example, the first user may upload a record of the operation of removing the first coating film from the first vehicle to the server apparatus through a terminal used by the first user. In that case, the controller of the information processing apparatus may execute the processing of giving an incentive to the first user on condition that a record of the operation of removing the first coating film is stored in the server apparatus. Thus, it is possible to keep the history record of operations relating to the first coating film of the first vehicle, even in the case where the operation of removing the first coating film is not performed at the specific site.

### Embodiment

In the following, an embodiment of the technology disclosed herein will be described with reference to the drawings. It should be understood that features that will be described in the following description of the embodiment are not intended to limit the technical scope of the disclosure only to them, unless otherwise stated.

What is described in the following as an embodiment is a case where the technology disclosed herein is applied to a system that provides the service of buying and selling used vehicles. This system will also be referred to as “used vehicle sales system” hereinafter. The information processing apparatus according to this disclosure can also be applied to a system that provides the service of leasing vehicles.

### General System Configuration

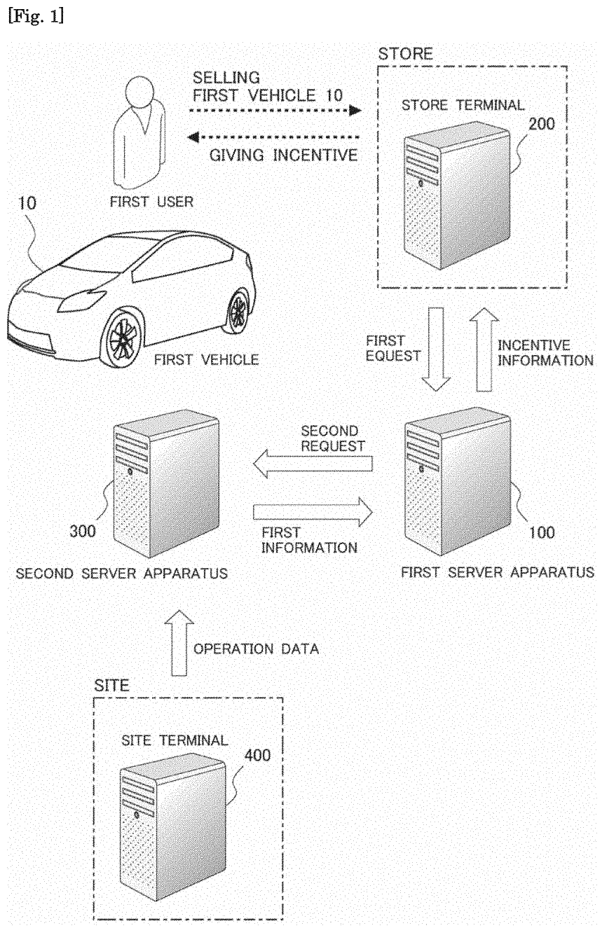

FIG. 1 is a diagram illustrating the general configuration of a used. vehicle sales system to which the information processing apparatus according to the present disclosure is applied. The used vehicle sales system of this embodiment includes a first server apparatus 100 that manages buying and selling of used vehicles, a store terminal 200 used in a store where used vehicles are bought and sold, a second server apparatus 300 that collectively manages records of operations relating to overcoatings of vehicles, and a site terminal 400 used in a specific site at which operations relating to overcoating of vehicles are performed. While the exemplary system illustrated in FIG. 1 includes only one first server apparatus 100, one store terminal 200, and one site terminal 400, the system may include a plurality of first server apparatuses 100, store terminals 200, and site terminals 400.

The first server apparatus 100 is a server apparatus that manages buying and selling of used vehicles at the store. The first server apparatus 100 constitutes an example of the information processing apparatus according to the present disclosure. The first server apparatus 100 is run by a business entity that provides the service of buying and selling used vehicles.

When the operation of buying a vehicle from which overcoating has been removed (or first vehicle 10) is performed at the store, the first server apparatus 100 in the system of this embodiment executes various processing relating to giving an incentive to the first user who sells the first vehicle 10. The term “overcoating” refers to a removable coating film applied on the original coating applied to the body of the first vehicle 10 in the process of its manufacturing. The overcoating corresponds to the first coating film according to the present disclosure. Details of the overcoating will be specifically described later.

When the operation of buying the first vehicle 10 from which the overcoating has been removed is performed at the store, the first server apparatus 100 determines an incentive to be given to the first user in response to a first request sent from the store terminal 200, which will be described later, and provides information about the incentive thus determined (which will also be referred to as “incentive information” hereinafter) to the store terminal 200. The first request; is a request for assessment to determine the incentive to be given to the first user. The first request contains a vehicle ID for identifying the first vehicle 10, such as the vehicle identification number or the vehicle registration number. When the first server apparatus 100 receives the first request, it sends a second request to the second server 300, which will be described later. The second request is a signal that requests the supply of the history record of operations relating to the overcoating of the first vehicle 10. The second request contains the vehicle ID of the first vehicle 10. When the first server apparatus 100 receives a response to the second request (or first information) from the second server apparatus 300, the first server apparatus 100 determines whether an incentive is to be given to the first user on the basis of the first information. If it is determined that an incentive is to be given to the first user, the first server apparatus 100 calculates the value of the incentive to be given to the first user on the basis of the first information. The results of the determination and the calculation by the first server apparatus 100 is sent from the first server apparatus 100 to the store terminal 200 as the aforementioned incentive information. If it is determined that an incentive is not to be given to the first user, only the result of this determination by the first server apparatus 100 is sent from the first server apparatus 100 to the store terminal 200 as the incentive information.

The store terminal 200 is a computer used by staffs of a store where used vehicles are bought from users and sold to users. The store terminal 200 may be either a stationary computer provided in the store or a tablet computer that the store staff can carry. The store terminal 200 in the system of this embodiment has the function of sending the first request to the first server apparatus 100 when the operation of buying the first vehicle 10 is performed. The store terminal 200 sends the first request when it receives entry of the vehicle ID by store staff,

The store terminal 200 also has the function of presenting the incentive information sent from the first server apparatus 100 to the store staff. The staff to whom the incentive information is presented performs an operation according to the incentive information. For example, the result of the determination by the first server apparatus 100 indicates that an incentive is to be given to the first user, the staff gives the incentive according to the result of the calculation by the first server apparatus 100 to the first user. If the result of the determination by the first server apparatus 100 indicates that an incentive is not to be given to the first user, the staff does not give the incentive to the first user.

The incentive used in the system of this embodiment may be an increase in the price at which the store buys the first vehicle 10, points that can be used in the store, a discount of the price of a used vehicle that the user purchases from the store, or money. The incentive is not limited to the above but may be anything that is profitable for the first user.

The function of receiving entry of the vehicle ID by the store staff, the function of sending the first request to the first server apparatus 100, and the function of presenting the incentive information sent from the first server apparatus 100 to the store staff may be implemented by a browser running on the store terminal 200 or an application program(s) installed in the store terminal 200. Some or all of these functions may be implemented by a hardware circuit, such as an ASIC (Application Specific Integrated Circuit) or an FPGA (Field Programmable Gate Array).

The second server apparatus 300 collectively manages records of operations relating to overcoatings of a plurality of vehicles including the first vehicle 10. For example, the second server apparatus 300 may have a database in which the vehicle IDs of the vehicles and records of operations relating to the overcoatiligs of the respective vehicles linked with them are stored. Examples of the records of operations relating to the overcoating include information about the operation of applying overcoating on the original coating of each vehicle (e.g. information about the date and time of the application, the place at which the application was performed, and the employed method of application) and information about the operation of removing overcoating from each vehicle (e.g. information about the date and time of the removal, the place at which the removal was performed, and the employed method of removal). The operation records managed by the second server apparatus 300 are created based on operation data provided by the site terminal 400, which will be described later.

The second server apparatus 300 has the function of receiving the second request sent from the first server apparatus 100 and providing the first information to the first server apparatus 100. For example, the second server apparatus 300 picks up the operation record linked with the vehicle ID contained in the second request. Then, the second server apparatus 300 provides the picked-up operation record to the first server apparatus 100 as the first information. Then, the first server apparatus 100 can determine whether an incentive is to be given to the first user.

The operation records managed by the second server apparatus 300 are updated based on operation data provided by the site terminal 400, which will be described later.

The site terminal 400 is a computer used by the staffs of a specific site. The site terminal 400 may be either a stationary computer provided at the specific site or a tablet computer that the staffs of the site can carry. In the system of this embodiment, the specific site is a site at which the operation of applying overcoating and/or the operation of removing overcoating are performed as business operations. The specific site is also a site at which operation data relating to overcoating can be uploaded to the second server apparatus 300 through the site terminal 400. Examples of the specific site include a car dealer or a maintenance workshop having partnership with the manufacturer of the first vehicle 10.

The operation data uploaded from the site terminal 400 to the second server apparatus 300 includes a site ID for identifying the specific site, the vehicle ID of the vehicle for which the operation was performed, the date and time at which the operation relating to overcoating was performed, and information about the operation relating to overcoating. Examples of the information about the operation relating to overcoating include information indicating whether overcoating was applied or removed and information about the employed method of applying or removing the overcoating.

The site terminal 400 receives entry of information about an operation relating to overcoating made by a staff and creates operation data by adding the site ID and the vehicle ID to the received information. Then, the site terminal 400 uploads the operation data thus created to the second server apparatus 300. Uploading of the operation data from the site terminal 400 to the second server apparatus 300 may be executed every time a staff enters information about the operation relating to overcoating or at a regular interval (e.g. several hours, several days, or several weeks).

The function of receiving entry of information about an operation relating to overcoating made by a staff, the function of creating operation data, and the function of uploading the operation data to the second server apparatus 300 may be implemented by a browser running on the site terminal 400 or an application program(s) installed in the site terminal 400. Some or all of these functions may be implemented by a hardware circuit, such as an ASIC (Application Specific Integrated Circuit) or an FPGA (Field Programmable Gate Array).

### Overcoating

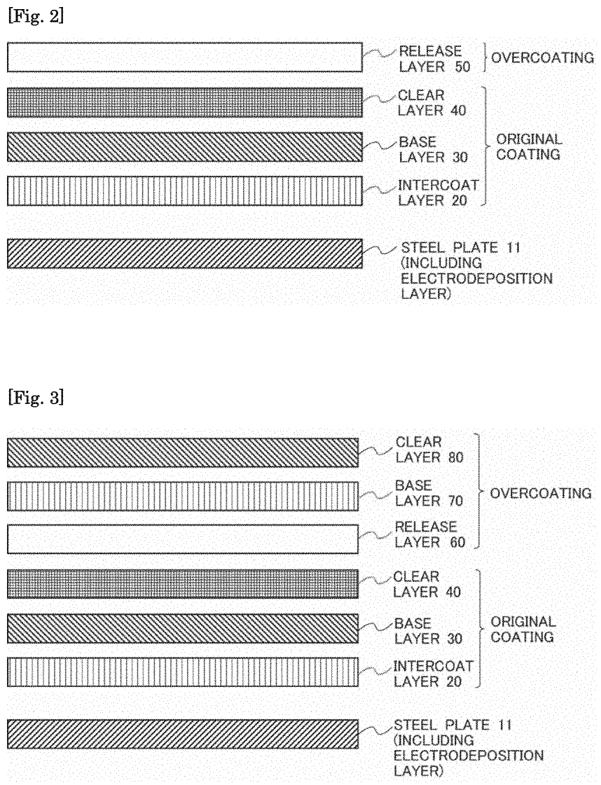

Overcoating applied to the first vehicle 10 will now be described. FIG. 2 is a diagram illustrating the general structure of a coating films applied on the first vehicle 10. As illustrated in FIG. 2, the first vehicle 10 has original coating applied on the steel plate 11 that constitutes the body of the first vehicle 10, and overcoating is applied on the original coating. The original coating includes an intercoat layer 20 formed on the surface of the steel plate 11, a base layer 30 formed on the intercoat layer 20, and a clear layer (or topcoat) 40 formed on the base layer 30. The steel plate 11 includes an electrodeposition layer applied as primer coating. In the case where the material constituting the body of the first vehicle 10 is a resin, a primer layer may be formed instead of the intercoat layer 20 in the original coating. The original coating formed in this way is not easy to be removed, because its removal requires a particular solution, such as a remover.

The overcoating includes a release layer 50 formed on the original coating (namely, on the clear layer 40). The release layer 50 is a layer of an easily-removable coating material, which, by its properties, can be removed easily by application of force. The release layer 50 shown in FIG. 2 corresponds to the coating film including an easily removable layer (or first coating film) according to the present disclosure, The release layer 50 is formed by, for example, applying an easily-removable coating material on the original coating by spraying. The easily-removable coating material may be, for example, a coating material containing xylene, ethylbenzene, antioxidant, methyl ethyl ketone, silica reactant, titanium oxide (in the form of nanoparticles), and an organic solvent. A clear layer may be additionally formed on the release layer 50.

The overcoating shown in FIG. 2 uses a paint material that in itself has removability. However, the structure of the overcoating is not limited to that shown in FIG. 2, but the overcoating may be any coating film, so long as it is easy to remove. For example, as illustrated in FIG. 3, a release layer 60 may be formed on the clear layer 40 of the original coating, and a base layer 70 and a clear layer 80 may be formed on the release layer 60. The release layer 60 shown in FIG. 3 is a non-tinted layer made of the same material as the release layer 50 in FIG. 2. In this case, the release layer 60 corresponds to the easily-removable layer according to the present disclosure, and the overcoating including the release layer 60, the base layer 70, and the clear layer 80 correspond to the coating film including an easily removable layer (or first coating film) according to the present disclosure. The overcoating shown in FIG. 3 can be removed easily from the original coating by application of force to the release layer 60.

By using the above overcoating, the body color of the first vehicle 10 can easily be changed to a color different from the color of the original coating. The body color of the first vehicle 10 can easily be changed back to the color of the original coating by removing the overcooling. Therefore, when purchasing the first vehicle 10, the user can select a vehicle having original coating of a color popular in the resale market or the like and uses the first vehicle 10 after applying overcoating of a color different from the original coating. When selling the first vehicle 10 in the resale market or the like, the user can remove the overcooling to change the body color back to the color of the original coating, which is popular in the resale market. Thus, the first vehicle 10 can be sold quickly at a high price. From the standpoint of the business entity that provides the service of buying and selling used vehicles, buying a vehicle of which the overcooling has been removed from the user can reduce the cost and effort of removing the overcooling. However, unless the overcoating is removed in a manner in which a record of the operation of removing the overcooling is stored in the second server apparatus 300, it would be difficult to know the history and/or the present condition of the first vehicle 10 correctly in some cases.

### System Configuration

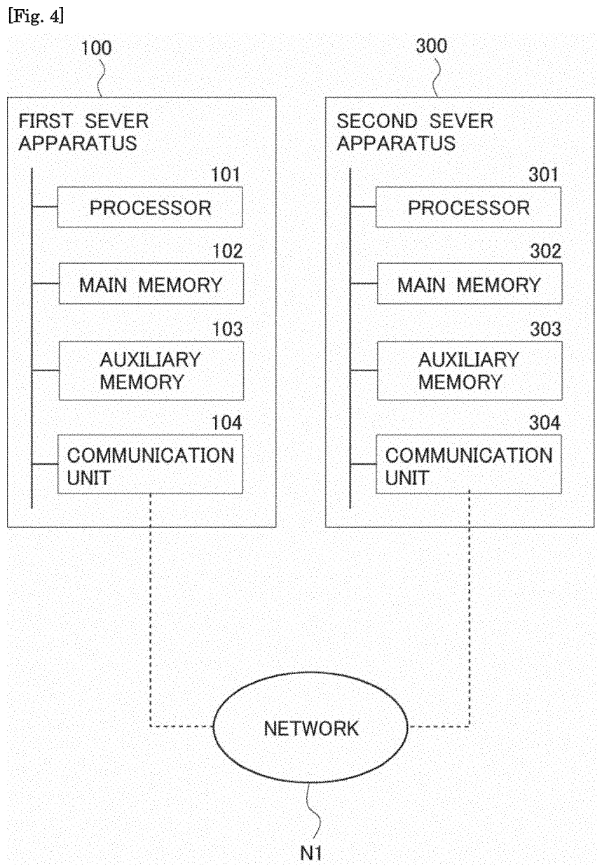

FIG. 4 is a diagram illustrating exemplary hardware configurations of the first server apparatus 100 and the second server apparatus 300 in the used vehicle sales system of this embodiment.

The first server apparatus 100 is a computer provided in a business place that controls stores. As illustrated in FIG. 4, the first server apparatus 100 includes a processor 101, a main memory 102, an auxiliary memory 103, and a communication unit 104. The processor 101, the main memory 102, the auxiliary memory 103, and the communication unit 104 are interconnected by buses. The hardware configuration of the first server apparatus 100 is not limited to that illustrated in FIG. 4, but some components may be eliminated, replaced by other components, or added fitly.

The processor 101 executes various information-processing computations to control the first server apparatus 100. The processor 101 is constituted by, for example, a CPU (Central Processing Unit) or a DSP (Digital Signal Processor).

The main memory 102 is a storage device used as a recording area to which programs stored in the auxiliary memory 103 is loaded or a buffer in which results of computations by the processor 101 is temporarily stored. The main memory 102 may include, for example, a semiconductor memory, such as a ROM (Read Only Memory) and a RAM (Random Access Memory).

The auxiliary memory 103 stores, for example, programs to be executed by the processor 101 and data used in the execution of the programs by the processor 101. The auxiliary memory 103 includes, for example, an EPROM (Erasable Programmable ROM) or an HDD (Hard Disk Drive). The auxiliary memory 103 may include a removable medium. The removable medium may be a disc recording medium, such as a CD (Compact Disc) or a DVD (Digital Versatile Disc), or a USB (Universal Serial Bus) memory. The programs stored in the auxiliary memory 103 include an OS (Operating System) and an application program relating to assessment to determine the incentive. All or a portion of the information stored in the auxiliary memory 103 may be stored in the main memory 102 instead.

The communication unit 104 is a communication interface that connects the first server 100 to a network N1. The communication unit 104 is connected to the network N1 by using a communication network, such as LAN (Local Area Network). The communication unit 104 may be connected to the network N1 by using a wireless communication network, such as Wi-Fi (registered trademark). The communication unit 104 communicates with other devices (e.g. the store terminal 200 and the second server apparatus 300) through the network N1.

The network N1 may be, for example, a WAN (Wide Area Network), which may be a global public communication network such as the Internet, or other communication network. The network N1 may include a telephone communication network, such as a cellular phone network, or a wireless communication network, such as Wi-Fi (registered trademark).

The second server apparatus 300 is run by the manufacturer that produces vehicles including the first vehicle 10 or a business entity commissioned by the manufacturer. The second server apparatus 300 is a computer provided in a business place of the manufacturer or other entity. As illustrated in FIG. 4, the second server apparatus 300 includes a processor 301, a main memory 302, an auxiliary memory 303, and a communication unit 304. The processor 301, the main memory 302, the auxiliary memory 303, and the communication unit 304 are interconnected by buses. The hardware configuration of the second server apparatus 300 is not limited to that illustrated in FIG. 4, but some components may be eliminated, replaced by other components, or added fitly.

The processor 301, the main memory 302, the auxiliary memory 303, and the communication unit 304 of the second server apparatus 300 are similar to the processor 101, the main memory 102, the auxiliary memory 103, and the communication unit 104 of the first server apparatus 100 and will not be described further.

### Functional Configuration of First Server Apparatus

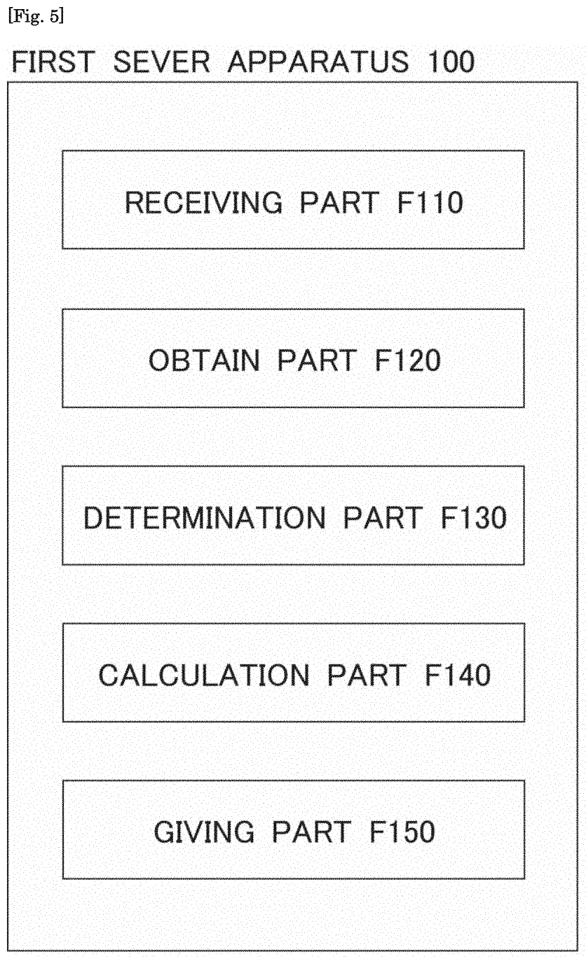

The functional configuration of the first server apparatus 100 will now be described with reference to FIG. 5. The first server apparatus 100 in the system of this embodiment may be configured to constitute a web server that interacts with the store terminal 200. In that case, the store terminal 200 accesses the web server through a browser to enable operations such as making the contract of buying the first vehicle 10 from the first user, sending the first request to the first server apparatus 100, and receiving the incentive information from the first server apparatus 100. The first server apparatus 100 may provide the services same as the above by means other than a web server. For example, the first server apparatus 100 may execute the processing of enabling interactions with the store terminal 200 by an application program installed in the store terminal 200 and a certain protocol.

As illustrated in FIG. 5, the first server apparatus 100 configured to implement the above functions includes, as functional components, a receiving part F110, an obtaining part F120, a determination part F130, a calculation part F140, and a giving part F150, The receiving part F110, the obtaining part F120, the determination part F130, the calculation part F140, and the giving part F150 are implemented by the processor 101 by executing a program(s) stored in the auxiliary memory 103. The processor 101 that implements the above functional components corresponds to the controller according to the present disclosure. Some or all of the receiving part F110, the calculation part F140, and the giving part F150 may be implemented by a hardware circuit, such as an ASIC or an FPGA.

The receiving part F110 is one of the functional components that implement the aforementioned web server and interacts with the store terminal 200. For example, when the store terminal 200 accesses a certain web page (e.g. a web page for entering information needed to make the contract of buying the first vehicle 10 or a web page for entering information indicating the completion of the contract of buying the first vehicle 10), the receiving part F110 causes the browser of the store terminal 200 to display a screen for sending the first request to the first server apparatus 100. For example, this screen includes an entry field into which the vehicle ID of the first vehicle 10 is to be entered and a send button for sending the first request. If the vehicle ID is entered and the send button is operated on the above screen, the first request containing the vehicle ID is sent from the store terminal 200 to the first server apparatus 100, and the receiving part F110 receives it. The first request received by the receiving part F110 is passed from the receiving part F110 to the obtaining part F120.

The obtaining part F120 obtains the history record concerning the overcoating of the first vehicle 10 on the basis of the first request passed from the receiving part F110. Specifically, the obtaining part F120 sends a second request to the second server apparatus 300 through the communication unit 104. As described previously, the second request is a signal that requests the supply of the history record of operations relating to the overcoating of the first vehicle 10. The second request contains the vehicle ID of the first vehicle 10. The obtaining part F120 obtains first information sent from the second server apparatus 300 in response to the second request, through the communication unit 104. As described previously, the first information is information indicating the history record concerning the overcoating of the first vehicle 10. The first information obtained by the obtaining part F120 is passed from the obtaining part F120 to the determination part F130.

The determination part 130 determines whether an incentive is to be given to the first user, namely the seller of the first vehicle 10, on the basis of the first information. Specifically, the determination part F130 determines whether the first information includes a record of removal of the overcoating of the first vehicle 10 performed at the specific site, in other words whether the overcoating of the first vehicle 10 was removed at the specific site. If the first information includes a record of removal of the overcooling of the first vehicle 10 performed at the specific site, the determination part F130 determines that an incentive is to be given to the first user. Then, the result of the determination by the determination part F130 and the first information are passed from the determination part F130 to the calculation part F140. If the first information does not include a record of removal of the overcoating of the first vehicle performed at the specific site, the determination part F130 determines that an incentive is not to be given to the first user. Then, only the result of the determination by the determination part F130 is passed from the determination part F130 directly to the giving part F150.

In the case where it is determined by the determination part F130 that an incentive is to be given to the first user, the calculation part F140 calculates the value of the incentive to be given to the first user on the basis of the first information, In the system of this embodiment, the calculation part F140 calculates the value of the incentive to be given to the first user using the date and time of removal of the overcoating performed at the specific site among information included in the first information.

The longer the length of time elapsed since the removal of the overcoating performed at the specific site (which will also be referred to as “elapsed time length” hereinafter) is, the more the appearance of the original coating in the area from which the overcoating was removed can deteriorate (by, for example, damages or fading).

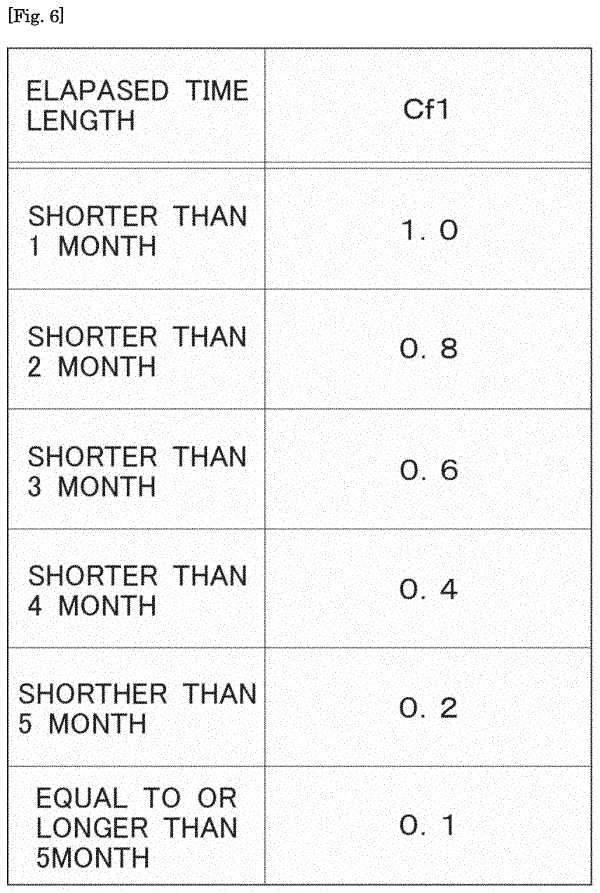

The calculation part F140 calculates the value of the incentive in such a way that the shorter the elapsed time length is, the larger the incentive to be given to the first user is. For example, the calculation part F140 determines a coefficient Cf1 in the manner shown in FIG. 6. As shown in FIG. 6, the coefficient Cf1 is a positive value not exceeding 1.0. The coefficient Cf1 is determined such that the shorter the elapsed time length is, the larger the value of the coefficient Cf1 is. For example, in the case where the elapsed time length is larger than five months, the coefficient cf1 is set to 0.1. In the case where the elapsed time length is shorter than five months, the coefficient Cf1 is increased with decreases in the elapsed time length to the maximum value 1.0 for the elapsed time length shorter than one month. The relationship shown in FIG. 6 may be stored in the auxiliary memory 103 in the form of a map or a calculation model. The values of the elapsed time length and the values of the coefficient Cf1 shown in FIG. 6 are given only by way of example, and their values are not limited to those shown in FIG. 6.

After determining the coefficient Cf1 in the above-described manner, the calculation part F140 calculates the value of the incentive to be given to the first user by multiplying a base value Icdef of the incentive by the coefficient Cf1. The base value Icdef is the maximum value of the incentive, which is the value (of money or points etc.) to be given to the first user in the case where the elapsed time length is shorter than one month. The shorter the elapsed time length is, the larger the value of the incentive calculated in this way is. The value of the incentive calculated by the calculation part F140 is passed from the calculation part F140 to the giving part F150 together with the result of determination by the F130.

The method of calculating the incentive is not limited to the method described above, but any method may be employed so long as the shorter the elapsed time length is, the larger the calculated value of the incentive is.

Referring again to FIG. 5, the giving part F150 is one of the functional components that implement the aforementioned web server and interacts with the store terminal 200, as with the obtaining part F120. For example, the giving part F150 causes the browser of the store terminal 200 to display incentive information. In the case where it has been determined by the determination part F130 that an incentive is not to be given to the first user, the giving part F150 causes the browser of the store terminal 200 to display the incentive information including only the result of this determination. In the case where it has been determined by the determination part F130 that an incentive is to be given to the first user, the giving part F150 causes the browser of the store terminal 200 to display the incentive information including the result of this determination and the value of the incentive calculated by the calculation part F140. Thus, the staff of the store can know whether or not an incentive is to be given to the first user and, in the case where an incentive is to be given to the first user, the value of the incentive.

The functional configuration of the first server apparatus 100 is not limited to that shown in FIG. 5, but some functional components may be eliminated, modified, or added.

### Functional Configuration of Second Server Apparatus

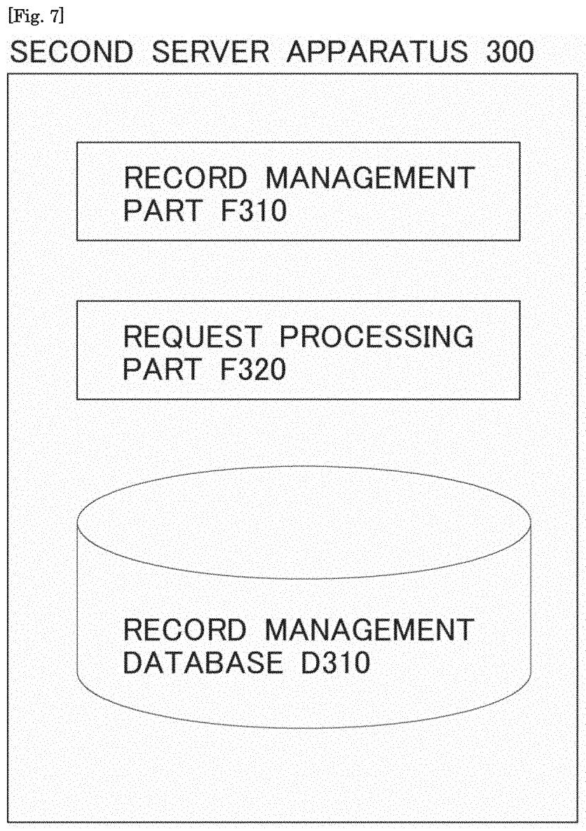

The functional configuration of the second server apparatus 300 will now be described with reference to FIG. 7. The second server apparatus 300 of this embodiment may be configured to constitute a web server that interacts with the first server 100 and the site terminal 400. In that case, the first server apparatus 100 and the site terminal 400 may access the web server through a browser to input and output information. The second server apparatus 300 may provide the services same as the above by means other than a web server. For example, the second server apparatus 300 may execute the processing of enabling interactions by application programs installed in the first server apparatus 100 and the site terminal 400 and a certain protocol.

As illustrated in FIG. 7, the second server apparatus 300 configured to implement; the above functions includes, as functional components, a record management part F310, a request processing part F320, and a record management database D310. The record management part F310 and the request processing part F320 are implemented by the processor 301 by executing a program(s) stored in the auxiliary memory 303. The record management database D310 is implemented by the processor 301 by executing a database management system program (DBMS program). The record management database D310 may be constructed as, for example, a relational database. The record management part F310 and/or the request processing part F320 may be constructed partly or entirely by a hardware circuit, such as an ASIC or a an FPGA.

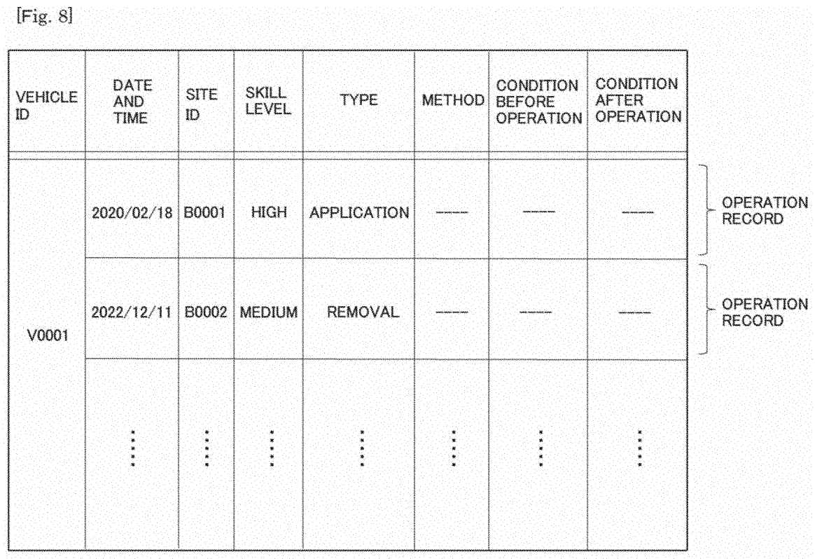

The record management database D310 stores records of operations relating to overcoating on a vehicle-by-vehicle basis. An example of information stored in the record management database D310 will now be described with reference to FIG. 8. FIG. 8 illustrates an exemplary table structure of information stored in the record management database D310. While FIG. 8 illustrates a table for one vehicle, the record management database D310 stores tables as many as the vehicles under the management of the second server apparatus 300. The structure of the table stored in the record management database D310 is not limited to that illustrated in FIG. 8, but some fields may be added, modified, or deleted. The table stored in the record management database D310 will also be referred to as “record information table” hereinafter.

As illustrated in FIG. 8, the record information table in the system of this embodiment has the fields of vehicle ID, date and time, site ID, skill level, type, method, condition before operation, and condition after operation.

What is stored in the vehicle ID field is the vehicle ID for identifying each vehicle (e.g. the vehicle identification number or the vehicle registration number) What is stored in the date and time field is information indicating the date and time at which the operation relating to the overcoating was performed. What is stored in the site ID field is the site ID for identifying the site at which the operation relating to the overcoating was performed. What is stored in the skill level field is information indicating the skill level of the site at which the operation relating to the overcoating was performed. What is stored in the type field is information indicating the type of the operation relating to the overcoating (e.g. application of the overcoating or removal of the overcoating). What is stored in the method field is information indicating the method of the operation relating to the overcoating (e.g. the method of applying the overcoating or the method of removing the overcoating). What is stored in the condition before operation field is information about the outer appearance of the vehicle before the operation relating to the overcoating was performed. This information corresponds to the second information according to the present disclosure. The information stored in the condition before operation field is information specifying the portion over which the overcooling had been applied or the portion over which the overcoating had not been applied before the operation relating to the overcoating was performed. For example, this information may be a photographic image of the vehicle taken before the operation relating to the overcoating was performed. What is stored in the condition after operation field is information about the outer appearance of the vehicle after the operation relating to the overcoating was performed. This information corresponds to the third information according to the present disclosure. The information stored in the condition after operation field is information specifying the portion over which the overcoatmg was applied or the portion over which the overcoating was not applied at the time of completion of the operation relating to the overcooling. For example, this information may be a photographic image of the vehicle taken at the time of completion of the operation relating to the overcoating.

Referring again to FIG. 7, the record management part F310 updates the history record stored in the record management database D310 on the basis of operation data provided from the site terminal 400. For example, when overcoating is applied to the first vehicle 10 for the first time, the record management part F310 newly creates a record information table associated with the first vehicle 10 and stores this record information table in the record management database D310. Every time operation data is provided from the site terminal 400, the record management part F310 adds an operation record to the record information table associated with the vehicle.

The request processing part F320 executes processing for answering to the second request sent from the first server apparatus 100. For example, the request processing part F320 accesses the record management database D310 using the vehicle ID contained in the second request (i.e. the vehicle ID of the first vehicle 10) as an argument to find the record information table associated with the first vehicle 10. Then, the request processing part F320 retrieves the operation record (namely, the information stored in the fields of vehicle ID, date and time, site ID, skill level, type, method, condition before operation, and condition after operation) from the record information table thus found. Then, the request processing part F320 provides the first information including the operation record retrieved as above to the first server apparatus 100. Then, the first server apparatus 100 can determine whether the operation of removing the overcoating of the first vehicle 10 was performed at the specific site by determining whether the first information includes an operation record indicating that the overcoating of the first vehicle 10 was removed at the specific site. In the case where it is determined that the operation of removing the overcoating of the first vehicle 10 was performed at the specific site, the first server apparatus 100 can calculate the value of the incentive to be given to the first user on the basis of information about the date and time specified in the first information (i.e. the date and time at which the operation of removing the overcoating of the first vehicle 10 was performed at the specific site).

The functional configuration of the second server apparatus 300 is not limited to that shown in FIG. 7, but some functional components may be eliminated, modified, or added.

### Process Performed by First Server Apparatus

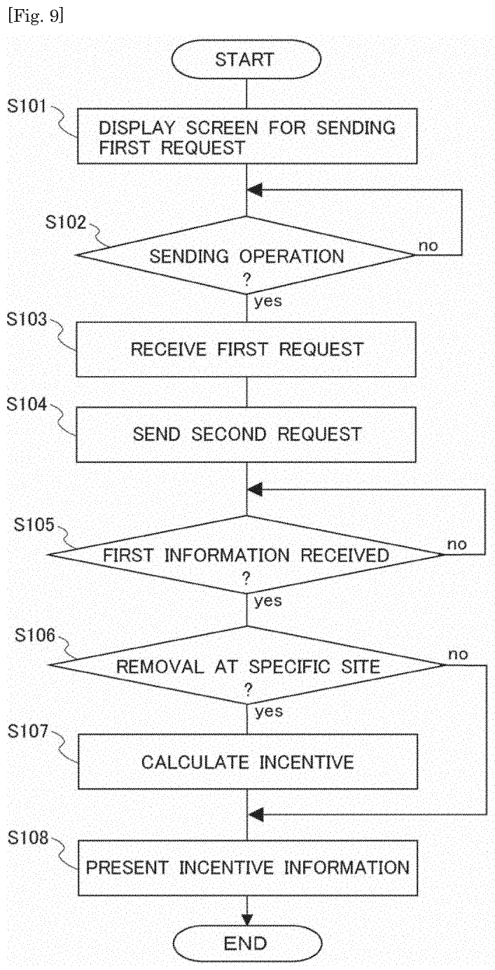

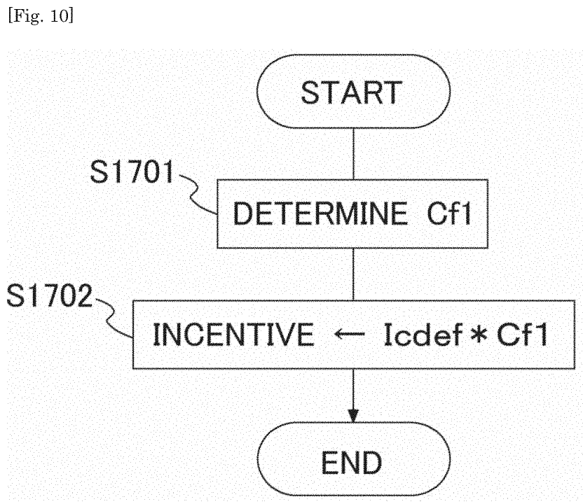

A process performed by the first server apparatus 100 according to the embodiment will now be described with reference to FIGS. 9 and 10. FIG. 9 is a flow chart of a processing routine executed by the first server apparatus 100 when access to the aforementioned web page is made by the store terminal 200 through its browser. FIG. 10 is a flow chart of a subroutine executed in step S107 in the flow chart of FIG. 9. While the processing according to the flow charts of FIGS. 9 and 10 is executed by the processor 101 of the first server apparatus 100, functional components thereof will be mentioned in the following description as components that execute various processing.

In the process according to the flow chart of FIG. 9, when access to the aforementioned web page is made by the store terminal 200 through its browser, the receiving part F110 causes the browser of the store terminal 200 to display a screen for sending the first request to the first server apparatus 100 (step S101). As described previously, the screen for sending the first request to the first server apparatus 100 includes an entry field into which the vehicle ID of the first vehicle 10 is to be entered and a send button for sending the first request. After executing the processing of step S101, the receiving part F110 executes the processing of step S102 next.

In step S102, the receiving part F110 determines whether the operation of the send button with the entry of the vehicle ID (or sending operation) has been performed in the screen displayed by the processing of step S101. If the sending operation has not been performed (a negative answer in step S102), the receiving part F110 waits until the sending operation is performed. If the sending operation has been performed (an affirmative answer in step S102), the receiving part F110 executes the processing of step S103 next.

In step S103, the receiving part F110 receives the first request containing the vehicle ID entered in the aforementioned screen. The first request received by the receiving part F110 is passed from the receiving part F110 to the obtaining part F120. Then, triggered by the reception of the first request, the obtaining part F120 executes the processing of step S104.

In step S104, the obtaining part F120 sends the second request to the second server apparatus 300. As described previously, the second request is a request for supply of the history record of operations relating to the overcoating of the first vehicle 10 and contains the vehicle ID of the first vehicle 10. The second request may be sent through the browser. After executing the processing of step S104, the obtaining part F120 executes the processing of step S105 next.

In step S105, the obtaining part F120 determines whether the first information has been received from the second server apparatus 300. If the first information has not been received from the second server apparatus 300 (a negative answer in step S105), the obtaining part F120 waits until the first information is received from the second server apparatus 300. If the first information has been received from the second server apparatus 300 (an affirmative answer in step S105), the obtaining part F120 passes the first information received from the second server apparatus 300 to the determination part F130. Then, triggered by the reception of the first information, the determination part F130 executes the processing of step S106.

In step S106, the determination part F130 determines whether the overcoating of the first vehicle 10 was removed at the specific site. Specifically, the determination part F130 determines whether the first information includes an operation record indicating that the overcoating of the first vehicle 10 was removed at the specific site. If the first information includes an operation record indicating that the overcoating of the first vehicle 10 was removed at the specific site (an affirmative answer in step S106), the determination part F130 passes the result of this determination and the first information to the calculation part F140. Then, triggered by the reception of the result of the determination by the determination part F130 and the first information, the calculation part F140 executes the processing of step S107.

In step S107, the calculation part F140 calculates the value of the incentive to be given to the first user on the basis of the first information. In this process, the calculation part F140 calculates the value of the incentive to be given to the first user by the subroutine according to the flow chart of FIG. 10.

In the process according to the flow chart of FIG. 10, the calculation part F140 determines the coefficient Cf1 on the basis of the first information received from the determination part F130 (step S1701). For example, the calculation part F140 calculates the elapsed time length on the basis of the date and time at which the overcoating of the first vehicle 10 was removed at the specific site specified in the first information. Then, the calculation part F140 determines the coefficient Cf1 on the basis of the elapsed time length and the relationship illustrated in FIG. 6 mentioned above. After executing the processing of step S1701, the calculation part F140 executes the processing of step S1702 next.

In step S1702, the calculation part F140 calculates the value of the incentive to be given to the first user by multiplying the base value Icdef of the incentive by the coefficient Cf1. After the calculation part F140 completes the processing of step S1702, the execution of the subroutine according to the flow chart of FIG. 10 is ended.

Returning back to the processing routine according to the flow chart of FIG. 9, the calculation part F140 passes the value of the incentive calculated in step S107 (namely, steps S1701 and S1702) to the giving part F150 together with the result of the determination by the determination part F130. Then, triggered by the reception of the value of the incentive and the result of the determination, the giving part F150 executes the processing of step S108.

In step S108, the giving part F150 presents incentive information to the staff of the store. Specifically, the giving part F150 causes the browser of the store terminal 200 to display the result of the determination by the determination part F130 and the value of the incentive calculated by the calculation part F140. Thus, the staff who sees the information displayed on the store terminal 200 can give the incentive as calculated by the first server apparatus 100 to the first user.

If step S106 is answered in the negative, in other words, if it is determined that the first information does not include an operation record indicating that the overcoating of the first vehicle 10 was removed at the specific site, the determination part F130 passes the result of this determination to the giving part F150. Then, in step S108, the giving part F150 causes the browser of the store terminal 200 to display the incentive information including only the result of the determination by the determination part F130.

After the giving part F150 completes the processing of step S108, the execution of the processing routine according to the flow chart of FIG. 9 is ended.

### Advantageous Effects Of System

The above-described system according to the embodiment gives an incentive to the first user who sells the first vehicle 10 after removing its overcoating at the specific site. Thus, the first user can get the incentive in reward for removing the overcoating of the first vehicle 10 at the specific site. This can motivate the first user to sell the first vehicle 10 after removing its overcoating at the specific site. This can lead to a reduction in the cost and effort required before selling the first vehicle 10 to the next purchaser. Moreover, it is possible to store the history record of operations relating to the overcoating of the first vehicle 10 in the second server apparatus 300. This helps the management of the history record of operations relating to the overcoating of the first vehicle 10,

The system according to the embodiment determines the incentive to be given to the first user in such a way that the shorter the elapsed time length is, the larger the incentive is. This can motivate the first user to sell the first vehicle 10 before the length of time elapsed since the removal of the overcoating at the specific site becomes long, in other words to remove the overcoating at the specific site immediately before selling the first vehicle 10. Thus, the business entity that provides the service of buying and selling used vehicles can buy the first vehicle 10 in a condition contributive to a higher resale value from the first user.

### First Modification of Embodiment

Described in the above description of the embodiment is a case where if it is determined that an incentive is to be given to the first user, the value of the incentive is calculated on the basis only of the elapsed time length. Described in the following as a first modification is a case where the value of the incentive is calculated on the basis of not only the elapsed time length but also the skill level of the site at which the operation of removing the overcoating of the first vehicle 10 was performed. The skill. level used in the calculation of the value of the incentive according to this modification is the skill level specified in the first information.

It is considered that the higher the skill level of the specific site at which the operation of removing the overcoating of the first vehicle 10 was performed is, the lower the possibility of damaging the original coating or leaving marks of removal in the operation of removing the overcoating is. Therefore, if it is possible to motivate the first user to remove the overcoating of the first vehicle 10 at a specific site with a high skill level, the business entity that provides the service of buying and selling used vehicles can buy the first vehicle 10 from which the overcoating has been removed neatly.

In view of the above, when it is determined that an incentive is to be given to the first user, the system of this modification calculates the value of the incentive in such a way that the shorter the elapsed time length is, and the higher the skill level of the specific site is, the larger the value of the incentive to be given to the first user is.

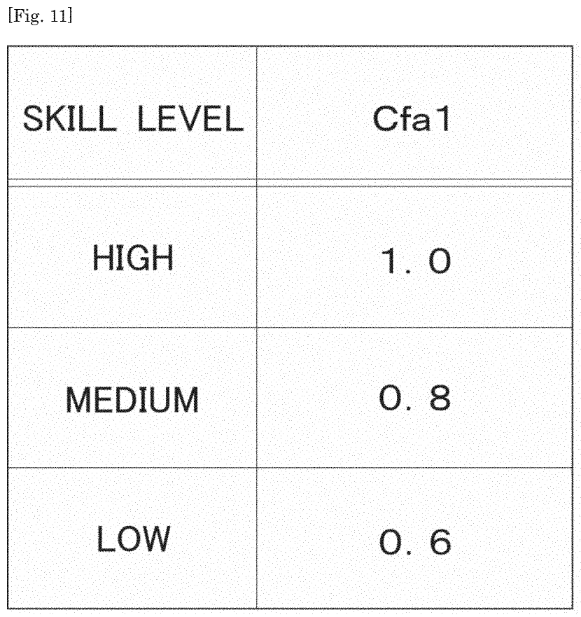

The calculation part F140 of this modification determines the coefficient Cf1 in the same manner as the above-described embodiment and further determines a first correction factor Cfa1 according to the relationship shown in FIG. 11. As shown in FIG. 11., the first correction factor Cfa1 is a positive number not exceeding 1.0. The first correction factor Cfa1 is determined such that the higher the skill level of the specific site is, the larger the value of the first correction factor Cfa1 is. While the skill level is divided into three levels in the case shown in FIG. 11, the number of levels is not limited to this. The skill level may be divided into two or more than three levels. The values of the first correction factor Cfa1 shown in FIG. 11 are given only by way of example, and the values are not limited to those shown in FIG. 11.

After determining the coefficient Cf1 and the first correction factor Cfa1 in the above-described manner, the calculation part F140 calculates the value of the incentive to be given to the first user by multiplying the base value Icdef of the incentive by the coefficient Cf1 and the first correction factor Cfa1. Consequently, the shorter the elapsed time length is, and the higher the skill level of the site at which the operation of removing the overcoating of the first vehicle 10 was performed is, the larger the value of the incentive calculated in this way will be.

The system of this modification can motivate the first user to sell the first vehicle 10 after removing the overcoating at the specific site and before the time elapsed since the removal of the overcoating at the specific site becomes long and to remove the overcoating at a specific site with a higher skill level. Thus, the business entity that provides the service of buying and selling used vehicles can buy the first vehicle 10 in a condition contributive to a higher resale value from the first user.

### Second Modification of Embodiment

Described in the above description of the embodiment is a case where if it is determined that an incentive is to be given to the first user, the value of the incentive is calculated on the basis only of the elapsed time length. Described in the following as a second modification is a case where the value of the incentive is calculated on the basis of not only the elapsed time length but also the sameness of the site at which the operation of removing the overcoating of the first vehicle 10 was performed and the site at which the operation of applying the overcoating of the first vehicle 10 was performed. The latter site will also be referred to as the “first site” hereinafter.

The site (first site) at which the operation of applying the overcoating of the first vehicle 10 was performed has information about properties of the overcoating applied to the first vehicle 10. Therefore, if the operation of removing the overcoating of the first vehicle is performed at the first site, the overcoating can be removed using a method suitable for the properties of the overcoating. For this reason, if the operation of removing the overcoating of the first vehicle 10 is performed at the first site, the overcoating can be removed more neatly than in the case where the operation of removing the overcoating is performed at a site other than the first site.

In view of the above, when it is determined that an incentive is to be given to the first user, the system of this modification calculates the value of the incentive in such a way that the shorter the elapsed time length is, the larger the incentive to be given to the first user is, and the incentive is made larger when the specific site is the same as the first site than when the specific site is not the same as the first site.

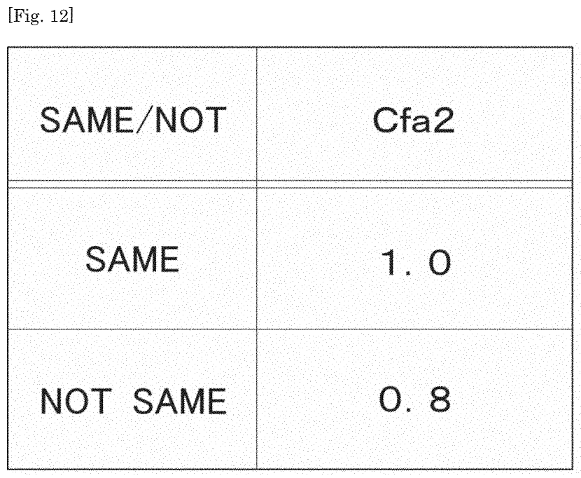

The calculation part F140 of this modification determines the coefficient Cf1 in the same manner as the above-described embodiment and further determines a second correction factor Cfa2 according to the relationship shown in FIG. 12. As shown in FIG. 12, the second correction factor Cfa2 is a positive number not exceeding 1.0. The second correction factor Cfa2 is determined such that its value is made larger when the specific site is the same as the first site than when the specific site is not the same as the first site. The values of the second correction factor Cfa2 shown in FIG. 12 are given only by way of example, and the values are not limited to those shown in FIG. 12.

Whether the specific site is the same as the first site is determined by the calculation part F140 on the basis of the first information. Specifically, the calculation part F140 determines whether the specific site is the same as the first site by comparing the site ID contained in the operation record concerning the application of the overcoating included in the first information and the site ID contained in the operation record concerning the removal of the overcoating included in the first information. If the two site IDs are the same, the calculation part F140 determines that the specific site is the same as the first site. If the two site IDs are not the same, the calculation part F140 determines that the specific site is not the same as the first site.

After determining the coefficient Cf1 and the second correction factor Cfa2 in the above-described manner, the calculation part F140 calculates the value of the incentive to be given to the first user by multiplying the base value Icdef of the incentive by the coefficient Cf1 and the second correction factor Cfa2. Consequently, the shorter the elapsed. time length is, the larger the value of the incentive calculated in this way will be, and the calculated value will be larger when the specific site is the same as the first site than when the specific site is not the same as the first site.

The system of this modification can motivate the first user to sell the first vehicle 10 after removing the overcoating at the specific site and before the time elapsed since the removal of the overcoating at the specific site becomes long and to remove the overcoating at the first, site. Thus, the business entity that provides the service of buying and selling used vehicles can buy the first vehicle 10 in a condition contributive to a higher resale value from the first user.

### Third Modification of Embodiment

Described in the above description of the embodiment is a case where if it is determined that an incentive is to be given to the first user, the value of the incentive is calculated on the basis only of the elapsed time length. Described in the following as a third modification is a case where the value of the incentive is calculated on the basis of not only the elapsed time length but also the proportion of the area over which the overcoating was removed at the specific site to the area over which the overcoating had been applied to the first vehicle. This proportion will also be referred to as the “first proportion” hereinafter.

The business entity that provides the service of buying and selling used vehicles can make the cost and effort of removing the overcoating from the first vehicle 10 smaller when the first proportion is large than when it is small. Therefore, if it is possible to motivate the first user to remove the overcoating of the first vehicle 10 at the specific site with a larger first proportion, the cost and effort that the business entity that provides the service of buying and selling the used vehicles is to bear can be made smaller.

In view of the above, when it is determined that an incentive is to be given to the first user, the system of this modification calculates the value of the incentive in such a way that the longer the length of elapsed time is, and the larger the first proportion is, the larger the incentive to be given to the first user is.

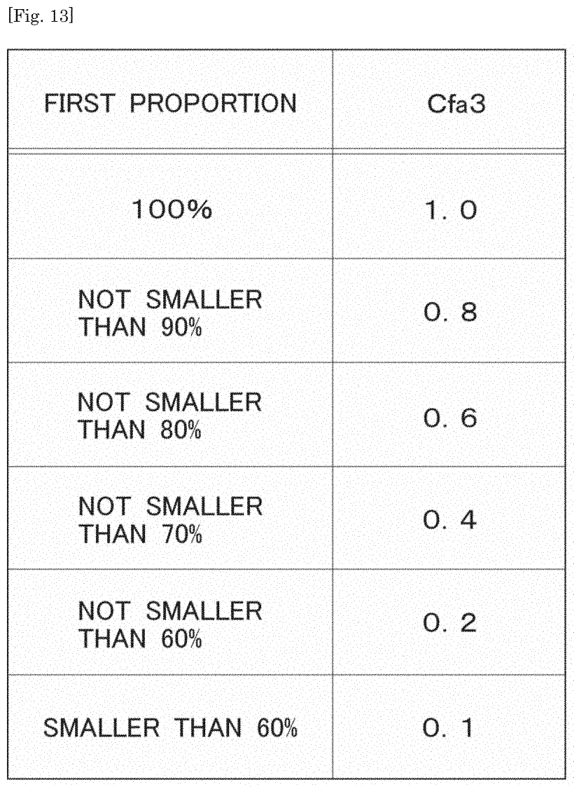

The calculation part F140 of this modification determines the coefficient Cf1 in the same manner as the above-described embodiment and further determines a third correction factor Cfa3 according to the relationship shown in FIG. 13. As shown in FIG. 13, the third correction factor Cfa3 is a positive number not exceeding 1.0. The third correction factor Cfa3 is determined such that the larger the first proportion is, the larger the value of the first correction factor Cfa1 is. In the illustrative case shown in. FIG. 13, if the first proportion is smaller than 60%, the third correction factor Cfa3 is set to 0.1. If the first proportion is equal to or larger than 60%, the third correction factor Cfa3 is increased up to the maximum value 1.0 as the first proportion increases to 100% (when there is no area where overcoating remains unremoved). The values of the first proportion and the third correction factor Cfa3 shown in FIG. 13 are given only by way of example, and the their values are not limited to those shown in FIG. 13.

The calculation of the first proportion is performed by the calculation part F140 on the basis of the first information. For example, the calculation part F140 calculates the first proportion by comparing the condition before operation (namely information about the outer appearance of the first vehicle 10 before the operation of removing the overcoating was performed) and the condition after operation (namely information about the outer appearance of the first vehicle 10 after the operation of removing the overcoating was performed) specified in the operation record concerning the removal of the overcoating included in the first information. In the case where the information about the condition before operation and after operation is photographic images of the outer appearance of the first vehicle 10, the calculation part F140 may analyze and compare the images to calculate the first proportion.

After determining the coefficient Cf1 and the third correction factor Cfa3 in the above-described manner, the calculation part F140 calculates the value of the incentive to be given to the first user by multiplying the base value lcdef of the incentive by the coefficient Cf1 and the third correction factor Cfa3. Consequently, the shorter the elapsed time length is, and the larger the first proportion is, the larger the value of the incentive calculated in this way will be.

The system of this modification can motivate the first user to sell the first vehicle 10 after removing the overcoating at the specific site and before the time elapsed since the removal of the overcoating at the specific site becomes long and to remove the overcoating with a larger first proportion. Thus, the business entity that provides the service of buying and selling used vehicles can buy the first vehicle 10 in a condition contributive to a higher resale value from the first user and reduce the cost and effort of removing the overcoating from the first vehicle 10.

### Another Embodiment

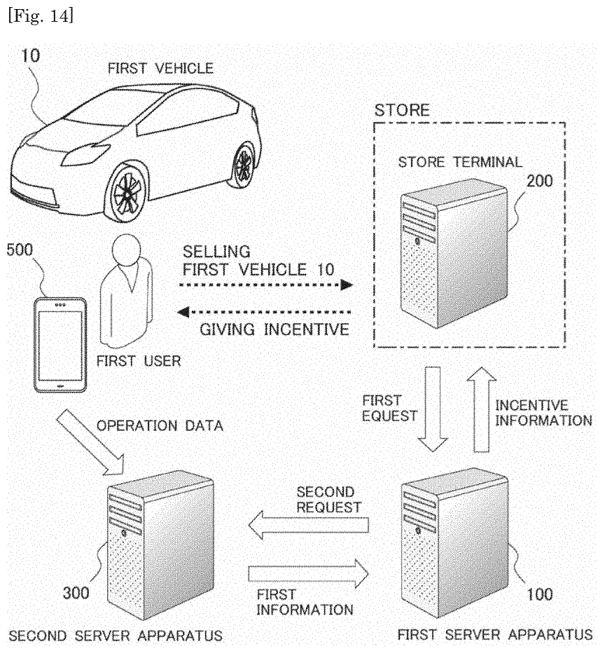

Another embodiment of the technology disclosed herein will be described with reference to FIG. 14. In the following description, features different from those in the above-described embodiment will be describe and similar features will not be described further.

FIG. 14 is a diagram illustrating the general configuration of a used vehicle sales system according to this embodiment. The used vehicle sales system of this embodiment includes a user's terminal 500 in place of the site terminal 400 in the above-described embodiment. The user's terminal 500 is a terminal used by the first user to upload operation data relating to the overcoating of the first vehicle 10 to the second server apparatus 300. In the system of this embodiment, operation data relating to the overcoating of the first vehicle 10 is uploaded to the second server apparatus 300 through the user's terminal 500 instead of the site terminal 400. Thus, the second server apparatus 300 can manage the history record of operations relating to the overcoating of the first vehicle 10 irrespective of whether operations relating to the overcoating of the first vehicle 10 are performed at the specific site or not.

The first server apparatus 100 in this used vehicle sales system may determine whether an incentive is to be given to the first user by determining whether a record of the operation of removing the overcoating of the first vehicle 10 is stored in the second server apparatus 300 (in other words, whether the first information includes a record of this operation) instead of determining whether the operation of removing the overcooling of the first vehicle 10 was performed at the specific site. For example, if a record of the operation of removing the overcoating of the first vehicle 10 is stored in the second sever apparatus 300, the first server apparatus 100 may determine that an incentive is to be given to the first user. If a record of the operation of removing the overcoating of the first vehicle 10 is not stored in the second sever apparatus 300, the first server apparatus 100 may determine that an incentive is not to be given to the first user.

Uploading of operation data to the second server apparatus 300 through the user's terminal 500 may be performed only when an operation relating to the overcoating is performed at a place other than the specific site. When an operation relating to the overcoating is performed at the specific site, operation data may be uploaded to the second server 300 through the site terminal 400 as in the above-described embodiment.

In the system of this embodiment, even in the case where an operation relating to the overcoating of the first vehicle 10 is performed at a place other than the specific site (for example, by the first user himself/herself), the second server apparatus 300 can manage the history record of the operations collectively,

### Others

The embodiment, the first to third modifications, and the other embodiment have been described only by way of example. Changes and modifications can be made to them without departing from the essence of this disclosure. For example, the processing performed by the first server apparatus 100 may be performed partly or entirely by another apparatus (e.g. the store terminal 200),

Processing and features described in this disclosure may be employed in any combination so long as it is technically feasible to do so. For example, processing and features of the embodiment, the first to third modifications, and the other embodiment may be employed in any combination so long as it is technically feasible to do so. One, some, or all of the processes that have been described as processes performed by one apparatus may be performed by a plurality of apparatuses in a distributed manner. Processes that have been described as processes performed by different apparatuses may be performed by one apparatus. The hardware configuration employed to implement various functions in a computer system may be modified flexibly.

The technology disclosed herein can be carried out by supplying a computer program(s) (i.e. information processing program) that implements the functions described in the above description of the embodiments to a computer to cause one or more processors of the computer to read and execute the program(s). Such a computer program(s) may be supplied to the computer by a computer-readable, non-transitory storage medium that can be connected to a system bus of the computer, or through a network. The computer-readable, non-transitory storage medium refers to a recording medium that can store information, such as data and programs, electrically, magnetically, optically, mechanically, or chemically in such a way as to allow the computer or the like to read the stored information. Examples of such a non-transitory, computer-readable recording medium include any type of discs including magnetic discs, such as a floppy disc (registered trademark) and a hard disk drive (HDD), and optical discs, such as a CD-ROM, a DVD, and a Blu-ray disc. The recording medium may be a ROM, a RAM, an EPROM, an. EEPROM, a magnetic card, a flash memory, an optical card, or a solid state drive (SSD).

What is claimed is:

1. An information processing apparatus comprising a controller including at least one processor, the controller being programmed to execute the processing of giving an incentive to a first user who sells or returns a first vehicle from which a first coating film including an easily removable layer was removed at a specific site.

2. The information processing apparatus according to claim 1, wherein the specific site is a site provided with a terminal used to upload operation data relating to the first coating film of the first vehicle to a server apparatus that manages history records of operations relating to the first coating films of a plurality of vehicles including the first vehicle.

3. The information processing apparatus according to claim 2, wherein the history record of operations relating to the first coating film of the first vehicle includes a record of the operation of applying the first coating film on the original coating of the first vehicle and a record of the operation of removing the first coating film from the first vehicle.

4. The information processing apparatus according to claim 3, wherein the controller executes the processing of:
sending a request for first information including the history record of operations relating to the first coating film of the first vehicle to the server apparatus;
receiving the first information from the server apparatus, and
determining whether an incentive is to be given to the first user on the basis of the first information.

5. The information processing apparatus according to claim 4, wherein if a record of the operation of removing the first coating film from the first vehicle performed at the specific site is included in the first information, the controller determines that the incentive is to be given to the first user,

6. The information processing apparatus according to claim 5, wherein the first information further includes information about a first date and time at which the operation of removing the first coating film from the first vehicle was performed at the specific site, and the controller calculates the value of the incentive to be given to the first user in such a way that the shorter the length of time elapsed since the first date and time is, the larger the value of the incentive is.

7. The information processing apparatus according to claim 5, wherein the first information further includes information about the skill level of the specific site at which the operation of removing the first coating film from the first vehicle was performed, and the controller calculates the value of the incentive to be given to the first user in such a way that the higher the skill level is, the larger the value of the incentive is.

8. The information processing apparatus according to claim 5, wherein the first information further includes information about a first site at which the first coating film was applied to the first vehicle, and the controller calculates the value of the incentive to be given to the first user in such a way as to make the value of the incentive larger when the specific site is the same as the first site than when the specific site is not the same as the first site.

9. The information processing apparatus according to claim 5, wherein the first information includes second information concerning the outer appearance of the first vehicle before the removal of the first coating film and third information concerning the outer appearance of the first vehicle after the removal of the first coating film, and the controller calculates the proportion of the area over which the first coating film was removed on the basis of the second information and the third information and calculates the value of the incentive to be given to the first user in such a way that the larger the proportion is, the larger the value of the incentive is.

10. An information processing method comprising the processing executed by a computer of giving an incentive to a first user who sells or returns a first vehicle from which a first coating film including an easily removable layer was removed at a specific site,

11. The information processing apparatus according to claim 10, wherein the specific site is a site provided with a terminal used to upload. operation data relating to the first coating film of the first vehicle to a server apparatus that manages history records of operations relating to the first coating films of a plurality of vehicles including the first vehicle.

12. The information processing method according to claim 11, wherein the history record of operations relating to the first coating film of the first vehicle includes a record of the operation of applying the first coating film on the original coating of the first vehicle and a record of the operation of removing the first coating film from the first vehicle.

13. The information processing method according to claim 12, further comprising the following processing executed by the computer:
sending a request for first information including the history record of operations relating to the first coating film of the first vehicle to the server apparatus;
receiving the first information from the server apparatus, and
determining whether an incentive is to be given to the first user on the basis of the first information,
wherein if it is determined that the incentive is to be given to the first user, the computer executes the processing of giving the incentive to the first user.

14. The information processing method according to claim 13, wherein if a record of the operation of removing the first coating film from the first vehicle performed at the specific site is included in the first information, the computer determines that the incentive is to be given to the first user.

15. The information processing method according to claim 14, wherein the first information further includes information about a first date and time at which the operation of removing the first coating film from the first vehicle was performed at the specific site, and the computer calculates the value of the incentive to be given to the first user in such a way that the shorter the length of time elapsed since the first date and time is, the larger the value of the incentive is.

16. The information processing method according to claim 14, wherein the first information further includes information about the skill level of the specific site at which the operation of removing the first coating film from the first vehicle was performed, and the computer calculates the value of the incentive to be given to the first user in such a way that the higher the skill level is, the larger the value of the incentive is.

17. The information processing method according to claim 14, wherein the first information further includes information about a first site at which the first coating film was applied to the first vehicle, and the computer calculates the value of the incentive to be given to the first user in such a way as to make the value of the incentive larger when the specific site is the same as the first site than when the specific site is not the same as the first site.

18. The information processing method according to claim 14, wherein the first information includes second information concerning the outer appearance of the first vehicle before the removal of the first coating film and third information concerning the outer appearance of the first vehicle after the removal of the first coating film, and the computer calculates the proportion of the area over which the first coating film was removed on the basis of the second information and the third information and calculates the value of the incentive to be given to the first user in such a way that the larger the proportion is, the larger the value of the incentive is.

19. An information processing apparatus comprising a controller including at least one processor, the controller being programmed to execute the processing of giving an incentive to a first user who sells or returns a first vehicle of which a record of the operation of removing a first coating film including an easily removable layer is stored in a server apparatus that manages history records of operations relating to the first coating films of a plurality of vehicles.

20. The information processing apparatus according to claim 19, wherein the record of the operation of removing the first coating film is uploaded to the server apparatus through a terminal used by the first user.
